(19) United States
(12) Patent Application Publication
(10) Pub. No.: US 2013/0262303 A1
(43) Pub. Date: Oct. 3, 2013

(54) SECURE TRANSACTIONS WITH A MOBILE DEVICE

(71) Applicant: Max Edward Metral, Brookline, MA (US)

(72) Inventor: Max Edward Metral, Brookline, MA (US)

(73) Assignee: eBay Inc., San Jose, CA (US)

(21) Appl. No.: 13/431,075

(22) Filed: Mar. 27, 2012

(51) Int. Cl. G06Q 20/18; G06Q 20/32

(52) U.S. Cl. 705/43

(57) ABSTRACT

A method for making financial transactions at an ATM are described. The method includes receiving indentifying information regarding a user, generating a security code, transmitting the code to a user's mobile device, receiving a code entered into the ATM by the user, comparing the code received to the code transmitted, and granting access to an account associated with the user if the codes match.

### BACKGROUND

1. Field of the Invention

The present invention generally relates to financial transactions using a mobile device at a physical location.

2. Related Art

Automated banking machines, such as automated teller machines (“ATMs”) are known and frequently used to carry out financial transactions. To address fraud and security concerns of financial transactions, “two-factor authentication” systems have been introduced, such as the ATM or debit card. Two-factor authentication systems require that a purchaser submit two unique forms of identification associated with the particular transaction.

Typically, a user inserts his ATM or debit card and enters a personal identification number (PIN) to access his account. However, the use of such cards and PINs may introduce fraud and security concerns in financial transactions because the card is easily replicable and the PIN is entered into a shared device. Financial transactions that take place at an ATM thus require a more robust form of identity authentication to verify that the user is authorized to conduct such a transaction.

Thus, it is desirable to provide methods and systems that provide more secure financial transactions at an ATM.

### SUMMARY

A user with a mobile device can perform secure financial transactions at an ATM without use of an ATM/debit card or a PIN. The ATM does not require a card reader to identify the user. The described methods identify and authenticate the user before the user is allowed to proceed with a financial transaction.

In one embodiment, a user authenticates his identity to a mobile application run by a service provider such as eBay, Inc. of San Jose, Calif., on a mobile communication device. The user can optionally configure the financial transaction on the mobile device before approaching the ATM. The service provider identifies the user, generates a code, and transmits the code to the user's mobile device. The user then inputs the code into the ATM, and if the service provider determines that the entered code matches the code transmitted, the user is granted access to the user account.

In another embodiment, a user enters a mobile phone number into an ATM. The ATM communicates the mobile number to a service provider, such as eBay, Inc. of San Jose, Calif., and the service provider receives the number. The service provider identifies the user associated with the mobile number, generates a code, and transmits the code to the user's mobile device. The user then inputs the code into the ATM, and if the service provider determines that the entered code matches the code transmitted, the user is granted access to a financial account associated with the mobile number.

These and other features and advantages of the present disclosure will be more readily apparent from the detailed description of the embodiments set forth below.

### BRIEF DESCRIPTION OF THE DRAWINGS

FIG. 1 is a block diagram of a networked system suitable for implementing the methods described herein according to an embodiment;

FIG. 2 is a flowchart showing a method of making financial transactions through a mobile device at an ATM according to one embodiment;

FIG. 3 is a flowchart showing a method of making financial transactions through a mobile device at an ATM according to another embodiment; and

FIG. 4 is a block diagram of a computer system suitable for implementing one or more components in FIG. 1 according to one embodiment of the present disclosure.

Embodiments of the present disclosure and their advantages are best understood by referring to the detailed description that follows. It should be appreciated that like reference numerals are used to identify like elements illustrated in one or more of the figures, wherein showings therein are for purposes of illustrating embodiments of the present disclosure and not for purposes of limiting the same.

### DETAILED DESCRIPTION

One or more embodiments of the present disclosure relate to facilitating and making financial transactions via a mobile communication device, such as a cellular phone, with an ATM. In various implementations, a user makes a financial transaction, i.e., withdrawing, depositing, and/or transferring funds at an ATM. After the user has been identified and authenticated, the user is allowed to carry out a financial transaction. In one aspect, a user profile may be created using the data obtained from cellular phone activity.

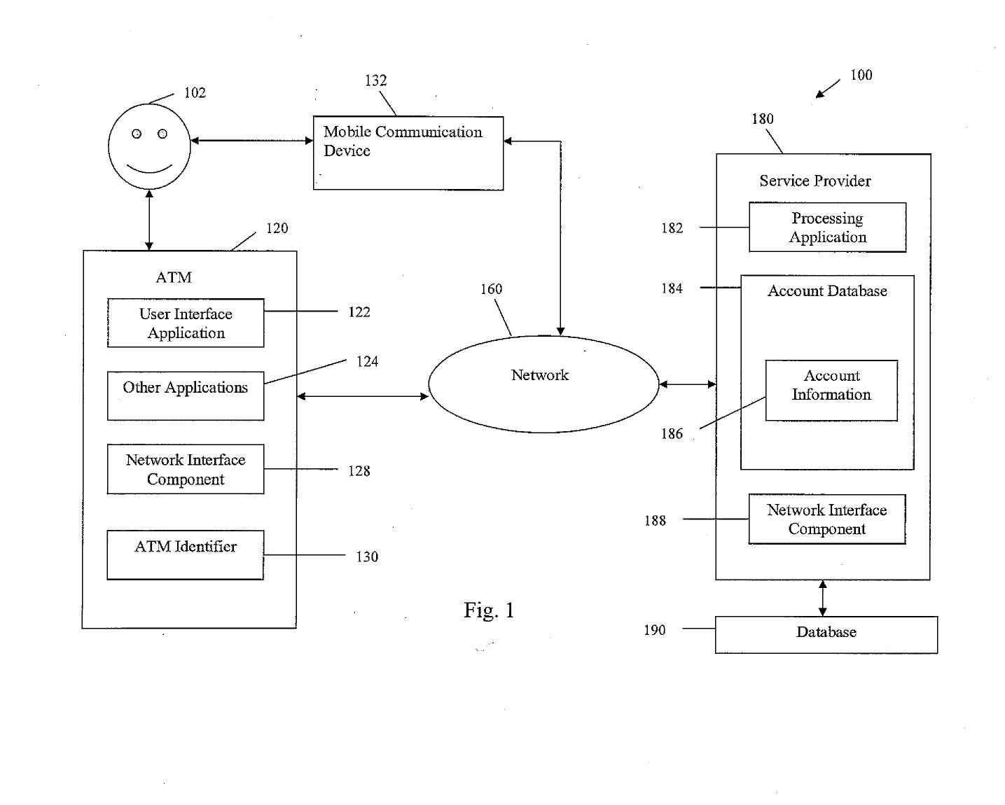

FIG. 1 shows one embodiment of a block diagram of a system 100 adapted to facilitate mobile transactions over a network 160. As shown in FIG. 1, the system 100 includes at least one ATM device 120, at least one mobile device 132, and at least one service provider server 180 in communication over the network 160.

The network 160, in one embodiment, may be implemented as a single network or a combination of multiple networks. For example, in various embodiments, the network 160 may include the Internet and/or one or more intranets, landline networks, wireless networks, and/or other appropriate types of communication networks. In another example, the network may comprise a wireless telecommunications network (e.g., mobile cellular phone network) adapted to communicate with other communication networks, such as the Internet.

The ATM device 120, in various embodiments, may be implemented using any appropriate combination of hardware and/or software configured for wired and/or wireless communication over the network 160. In various examples, the ATM device 120 may be implemented as a wired and/or wireless communication device (e.g., an automated user interface device) for a user 102 (e.g., a client or customer) to communicate with the network 160, such as the Internet and/or mobile network.

The ATM device 120 allows the user 102 to input data and information into an input component (e.g., a keyboard or keypad) of the ATM device 120 to provide user information with a transaction request, such as a cash deposit or withdrawal. The user information may include user identification information, including a user mobile number, which is described in greater detail herein. Keypads may also be used for receiving transaction amounts or other user-provided inputs. It should be understood for purposes of this disclosure that keypads can include touch screens or other devices that can receive user selectable inputs. The ATM device 120 does not require a card reader.

The ATM device 120 includes one or more user interface applications 122, which may be used by the user 102 to conduct financial transactions over the network 160. For example, the user interface application 122 may be implemented as an ATM application to deposit or withdraw cash into an account over the network 160. In one implementation, the user interface application 122 comprises a software program, such as a graphical user interface (GUI), executable by a processor that is configured to interface and communicate with the one or more service provider servers 180 via the network 160.

The ATM device 120, in various embodiments, may include one or more other applications 124 to provide additional features to the user 102. For example, these other applications 124 may include security applications for implementing client-side security features, programmatic client applications for interfacing with appropriate application programming interfaces (APIs) over the network 160 or various other types of generally known programs and/or applications.

The ATM device 120, in one embodiment, may include at least one network interface component (NIC) 128 adapted to communicate with the network 160. In various examples, the network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

The ATM device 120, in one embodiment, may include one or more ATM identifiers 130, which may be implemented as operating system registry entries, cookies associated with the user interface application 122, identifiers associated with hardware of the ATM device 120, and/or various other appropriate identifiers. The ATM identifier 130 may include attributes related to the ATM device 120, such as identification information (e.g., an ATM serial number, a location address, Global Positioning System (GPS) coordinates, a network identification number, etc.) and network information (e.g., network owner, network provider, network administrator, network security information, etc.). In various implementations, the ATM identifier 130 may be passed with network traffic data and information to the service provider server 180, and the ATM identifier 130 may be used by the service provider server 180 to associate one or more network transactions of the user 102 with one or more particular user accounts maintained by the service provider server 180.

The mobile communication device 132, in one embodiment, may be utilized by the user 102 to interact with the service provider server 180 over the network 160. For example, the user 102 may conduct financial transactions (e.g., account transfers) with the service provider server 180 via the mobile communication device 132. In various implementations, the mobile communication device 132 may include at least one of a wireless cellular phone, personal digital assistant (PDA), satellite phone, etc.

In various implementations, a user profile may be created using data and information obtained from cell phone activity over the network 160. Cell phone activity transactions may be used by the service provider server 180 to create at least one user profile for the user 102 based on activity from the mobile communication device 132 (e.g., cell phone). The user profile may be updated with each financial and/or information transaction (e.g., payment transaction, purchase transaction, etc.) achieved through use of the mobile communication device 132. In various aspects, this may include the type of transaction and/or the location information from the mobile communication device 132. As such, the profile may be used for recognizing patterns of potential fraud, setting transaction limits on the user, etc.

The mobile communication device 132, in one embodiment, may include a user identifier as one or more attributes related to the user 102, such as personal information (e.g., a user name, password, photograph image, biometric id, address, social security number, phone number, email address, etc.) and banking information (e.g., banking institution, credit card issuer, user account numbers, security information, etc.). In various implementations, the user identifier may be passed with network traffic data of the user 102 to the service provider server 180, and the user identifier may be used by the service provider server 180 to associate the user 102 with a user account maintained by the service provider server 180.

In various implementations, the user 102 is able to input data and information into an input component (e.g., a keyboard) of the mobile communication device 132 to provide user information with a transaction request, such as a fund transfer request. The user information may include user identification info nation.

The service provider server 180, in various embodiments, may be maintained by an online service provider, which is adapted to provide processing for financial transactions on behalf of the user 102. The service provider server 180 includes at least one processing application 182, which may be adapted to interact with the ATM device 120 and the mobile communication device 132 via the network 160 to facilitate financial transactions. In one example, the service provider server 180 may be provided by PayPal, Inc. of San Jose, Calif., USA.

The service provider server 180, in one embodiment, may be configured to maintain a plurality of user accounts in an account database 184, each of which may include account information 186 associated with individual users, including the user 102. For example, account information 186 may include balance information, fund transfer information, deposit information, etc. In another example, account information 186 may include identification information and/or private financial information of the user 102, such as account numbers, identifiers, passwords, phone numbers, credit card information, banking information, or other types of financial information, which may be used to facilitate online transactions between the user 102 of the ATM device 120 and the service provider server 180. It should be appreciated that the methods and systems described herein may be modified to accommodate users that may or may not be associated with at least one existing user account.

The service provider server 180, in various embodiments, may include at least one network interface component (NIC) 188 adapted to communicate with the network 160 including the network interface component 128 of the ATM device 120 and the mobile communication device 132. In various implementations, the network interface component 128 may comprise a DSL (e.g., Digital Subscriber Line) modem, a PSTN (Public Switched Telephone Network) modem, an Ethernet device, a broadband device, a satellite device and/or various other types of wired and/or wireless network communication devices including microwave, radio frequency (RF), and infrared (IR) communication devices.

The service provider server 180, in various embodiments, may include one or more databases 190 (e.g., internal and/or external databases) for storing and tracking information related to financial transactions between particular users, such as the user 102, and the service provider server 180. For example, the databases 190 may provide an historical survey of financial transactions between the user 102 and the service provider 180. As such, in one implementation, the processing application 182 may be configured to track, log, store, and access financial transaction information and provide this information to the processing application 182 for analysis and maintenance.

The database 190 may also store, for example, address data for calling the mobile communication device 132. The address data may include data for communicating a text message to the mobile device 132, an e-mail address at which messages are receivable by the mobile device 132, or any other manner for communicating with the mobile device 132 so as to enable the communication to be provided to the user 102 during the conduct of a particular transaction at an ATM. Moreover, service provider server 180 may include computer executable instructions that are operative to cause the server 180 to generate message content appropriate for messages to be communicated to the mobile device 132.

In various embodiments, the ATM device 120, the mobile communication device 132 and the service provider server 180 may be associated with a particular link (e.g., a link, such as a URL (Uniform Resource Locator) to an IP (Internet Protocol) address). In this regard, the user 102 may interface with the ATM device 120 and/or the mobile communication device 132 via the network 160 to facilitate financial transactions with the service provider server 180, which is discussed in greater detail herein.

In one implementation, the user 102 may run the user interface application 122 on the ATM device 120 to access at least one resource provider site via the service provider server 180 to view account information 186 related to the user 102. Access to the service provider site may be made available to the user 102 by the service provider server 180, wherein the service provider server 180 uses the processing application 182 to interact with the user 102 via the server provider site.

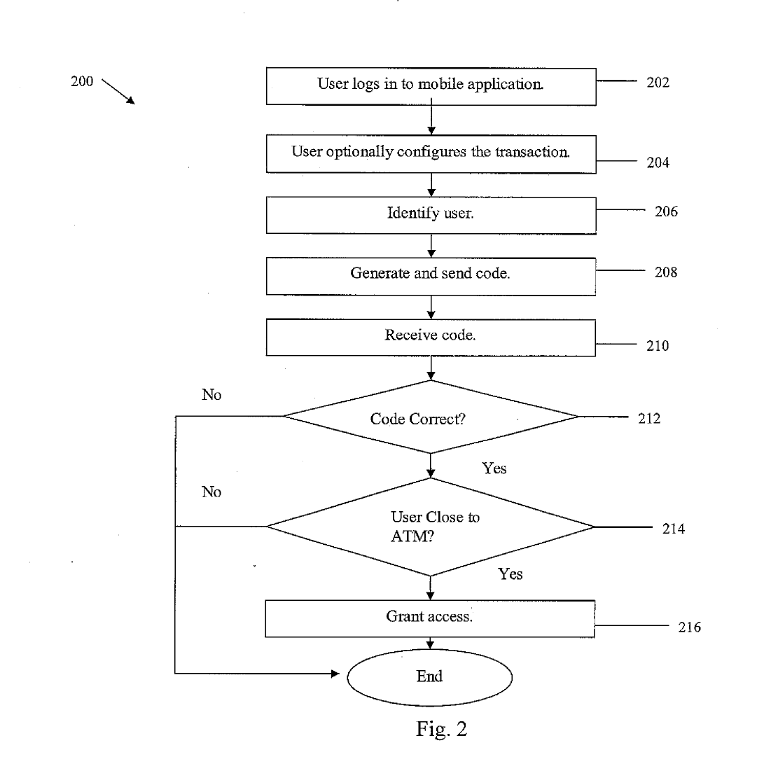

FIG. 2 is flow chart 200 showing a method of making financial transactions using a mobile device at an ATM, according to an embodiment. At step 202, the user 102 authenticates his identity by logging in to a mobile application on the mobile communication device 132. In one embodiment, the user 102 registers with a service provider, such as eBay or PayPal, which runs the mobile application. Registration may include signing up for the service and agreeing to any terms required by the service provider, such as through a user device. In one embodiment, the user device is a mobile computing device, such as a smart phone, a PC, or a computing tablet. In other embodiments, registration may be done completely through the user device, partially through the user device, or without using the user device, such as through a phone call or in-person visit to a representative of the service provider.

The user 102 may be requested to provider specific information for registration, such as, but not limited to, a name, address, phone number, email address, a user name for the account, and a password or PIN for the account. The type of information may depend on whether the user already has an account with the service provider. Requested information may be entered through the user device or other means, including voice or manual key entry. Once all the requested information is received and confirmed, the service provider may create an account for the user.

Before the user 102 can access his account, the service provider server 180 must first identify and authenticate the user 102. This is advantageously done without the use of an ATM or debit card, or a PIN. The method 200 involves the user 102 accessing a service provider site via the mobile communication device 132, which is adapted to communicate with the server provider server 180 via the network 160. Thus, the identification of the user 102 occurs primarily on the mobile device 132, rather than the ATM device 120. This adds a layer of security to the transaction.

The user 102 at step 204 may optionally configure the transaction on the mobile application before he approaches the ATM to make the transaction. For example, the user 102 can set up the type of transaction (withdrawal, deposit, or transfer), the amount of funds in the transaction, and select the account on the mobile application. In another embodiment, the user 102 may set up the transaction on the ATM device 120.

At step 206, the user 102 is identified by the service provider server 180. At step 208, the service provider server 180 generates and sends a security code to the mobile communication device 132. The code, in one embodiment, includes a random selection of letter, numbers, and/or symbols. In some exemplary embodiments, the code may be a random one-time use code that is generated through operation of the server 180 (or other computer in operative connection with the server 180) executing a random character generation program. The code may be sent to the mobile device 132 in any suitable way, including by email, phone, text, or push notification.

When the user 102 receives the code on the mobile device 132, the user 102 is required to input the code into the ATM device 120 for the transaction to proceed. The ATM device 120 receives from the user 102 the code that the server 180 caused to be sent to the mobile device 132 and sends the code through the network 160 to the service provider server 180.

Code entry can be time sensitive or for one-time use. The user 102 has a limited amount of time to enter the code into the ATM device 120. If the user 102 operating the ATM device 120 does not input the correct code within a given time period, the service provider server 180 may operate to cancel the transaction and return to its initial waiting state. In an exemplary embodiment, the code must be entered within five minutes of receipt.

At step 210, the service provider server 180 receives the code. The code is then compared and verified as the appropriate (e.g., same) code that was sent during the transaction to the mobile device 132 that is associated in database 190 with the user 102 in step 212. The server 180 operates to authenticate the identity of the user 102 and that a requested transaction at an ATM has been authorized by the actual owner of the account. This is accomplished by the user 102 being contacted at the mobile device 132 during the transaction through a particular network address associated with the mobile device 132.

If the code is determined to be correct at step 212, the method 200 proceeds to step 214. In step 214, the server 180 determines if the mobile communication device 132 is in proximity to the ATM device 120. A physical location of the mobile device 132 is compared to the location of the ATM device 120 to determine if they match or if the distance between the mobile device 132 and the ATM device 120 is acceptable. The step provides additional security to help prevent unauthorized ATM access to a financial account if it is determined that the location of the ATM device is different or too far from the location of the mobile device 132. Requiring that the mobile device 132 is at the same physical location as the ATM device 120 or within a certain distance from the ATM device 120 ensures that the user 102 is authorized to access the account related to the mobile device 132. If it is determined that the locations match, access is granted in step 216, and the user 102 can then make various financial transactions with respect to the user account. The user 102 can then withdraw, deposit, or transfer cash on the user account through the ATM device 120 or the mobile device 132.

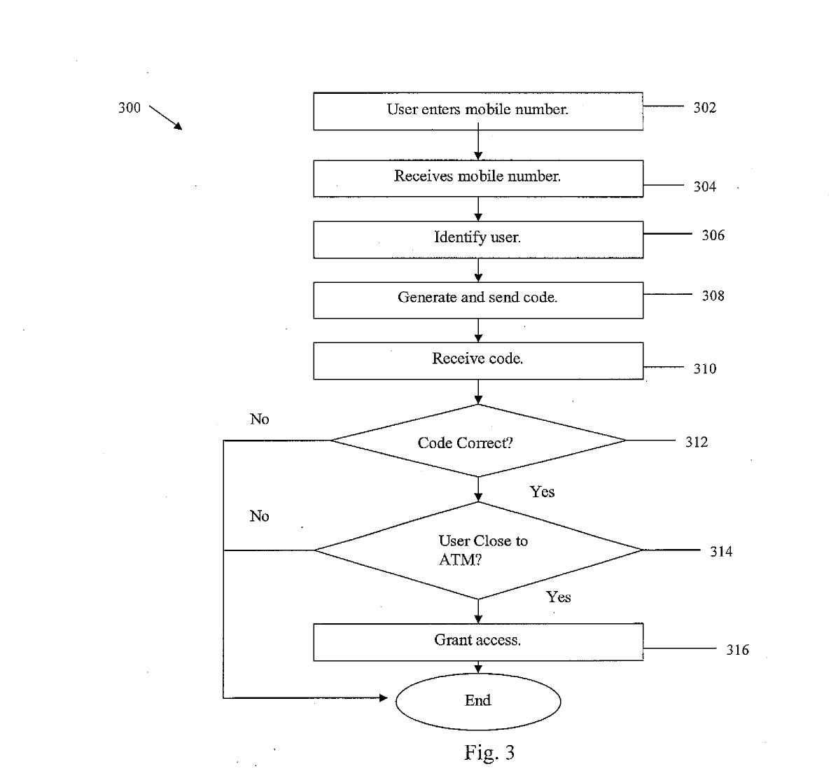

FIG. 3 is a flowchart 300 showing another embodiment of making financial transactions through a mobile device at an ATM. At step 302, the user 102 inputs identifying data, i.e., the user's mobile phone number, into the ATM device 120 to login to the service provider server 180. Before the user 102 can access his account, the service provider server 180 must first identify the user 102. This is advantageously done without the use of an ATM or debit card, or a PIN. The method 200 involves the user 102 accessing a service provider site via the ATM device 120, which is adapted to communicate with the sewer provider server 180 via the network 160.

At step 304, the service provider server 180 receives the mobile number entered. Proceeding to step 306, the user 102 is identified based on the mobile number entered. The ATM device 120 sends a message to the service provider server 180, which causes mobile device contact data to be obtained from database 190, which associates the mobile number with the user identifying data. The service provider server 180 determines the mobile number assigned to the user 102, and compares the received mobile number with the number assigned to the user 102 account. If they match, the user 102 is allowed to proceed to the next step 308. More than one mobile number can be assigned to a user account if more than one user is assigned to an account. In one aspect, the ATM device 120 serves as a gateway to the network 160 for access to an account related to the user 102.

Steps 308-314 are similar to steps 208-216 of FIG. 2, and thus, the descriptions of these steps are omitted for brevity.

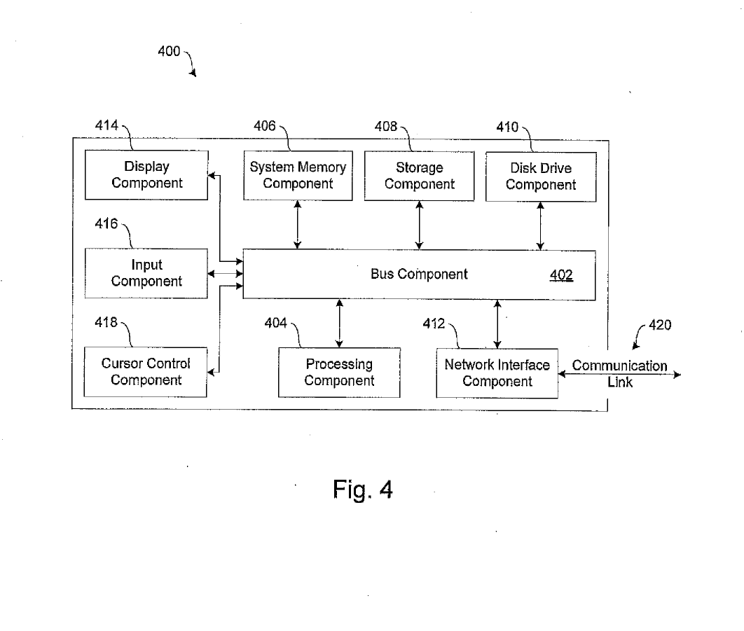

FIG. 4 is a block diagram of a computer system 400 suitable for implementing one or more embodiments of the present disclosure, including the ATM device 120, the mobile communication device 132, and the service provider server 180. In various implementations, the ATM device 120 may comprise a stand-alone computing device, such as an interactive computer terminal, the mobile communication device 132 may comprise a mobile cellular phone, personal computer (PC), laptop, PDA, etc. adapted for wireless communication, and the service processing device 180 may comprise a network computing device, such as a server. Thus, it should be appreciated that the devices 120, 132, 180 may be implemented as computer system 400 in a manner as follows.

In accordance with various embodiments of the present disclosure, computer system 400 includes a bus 402 or other communication mechanism for communicating information, which interconnects subsystems and components, such as processing component 404 (e.g., processor, micro-controller, digital signal processor (DSP), etc.), system memory component 406 (e.g., RAM), static storage component 408 (e.g., ROM), disk drive component 410 (e.g., magnetic or optical), network interface component 412 (e.g., modem or Ethernet card, such as the network interface components 128, 188 as discussed in reference to FIG. 1), display component 414 (e.g., CRT or LCD), input component 416 (e.g., keyboard), and cursor control component 418 (e.g., mouse or trackball). In one implementation, disk drive component 410 may comprise a database having one or more disk drive components.

In accordance with embodiments of the present disclosure, computer system 400 performs specific operations by processor 404 executing one or more sequences of one or more instructions contained in system memory component 404. Such instructions may be read into system memory component 406 from another computer readable medium, such as static storage component 408 or disk drive component 410. In other embodiments, hard-wired circuitry may be used in place of or in combination with software instructions to implement the present disclosure.

Logic may be encoded in a computer readable medium, which may refer to any medium that participates in providing instructions to processor 404 for execution. Such a medium may take many forms, including but not limited to, non-volatile media, volatile media, and transmission media. In various implementations, non-volatile media includes optical or magnetic disks, such as disk drive component 410, volatile media includes dynamic memory, such as system memory component 406, and transmission media includes coaxial cables, copper wire, and fiber optics, including wires that comprise bus 402. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various embodiments of the present disclosure, execution of instruction sequences to practice the present disclosure may be performed by computer system 400. In various other embodiments of the present disclosure, a plurality of computer systems 400 coupled by communication link 420 (e.g., network 160 of FIG. 1, LAN, WLAN, PTSN, or various other wired or wireless networks) may perform instruction sequences to practice the present disclosure in coordination with one another.

Computer system 400 may transmit and receive messages, data, information and instructions, including one or more programs (i.e., application code) through communication link 420 and communication interface 412. Received program code may be executed by processor 404 as received and/or stored in disk drive component 410 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present disclosure to the precise forms or particular fields of use disclosed. As such, it is contemplated that various alternate embodiments and/or modifications to the present disclosure, whether explicitly described or implied herein, are possible in light of the disclosure.

What is claimed is:

1. A method for making financial transactions at an automated teller machine (ATM), comprising:
authenticating, by a processor of a service provider, a user's identity through a mobile device;
generating a security code,
transmitting the code to a mobile device associated with the user identity;
receiving a code entered into the ATM;
comparing the code transmitted to the code entered; and
granting access to a financial account associated with the user identity if the code received matches the code transmitted.

2. The method of claim 1, wherein the code is time-sensitive, for one-time use, or both.

3. The method of claim 1, wherein the code is transmitted in the form of a text, phone call, email, push notification, or a combination thereof.

4. The method of claim 1, wherein the code comprises random alphanumeric characters.

5. The method of claim 1, wherein a card or personal identification number is not used to access the account.

6. The method of claim 1, further comprising determining information about a user location from the mobile device and information about a location of the ATM.

7. The method of claim 6, further comprising determining whether the user location and ATM location are the same.

8. The method of claim 1, wherein the user enters an amount to withdraw, deposit, and/or transfer through the mobile device.

9. A method for making financial transactions at an automated teller machine (ATM), comprising:
receiving, by a processor of a service provider, a user's mobile number entered into the ATM;
generating a security code,
transmitting the code to a mobile device associated with the mobile number received;
receiving a code entered into the ATM;
comparing the code transmitted to the code entered; and
granting access to a financial account associated with the mobile number received if the code received matches the code transmitted.

10. The method of claim 9, wherein the code is time-sensitive, for one-time use, or both.

11. The method of claim 9, wherein the code is transmitted in the form of a text, phone call, email, push notification, or a combination thereof.

12. The method of claim 9, wherein a card or personal identification number is not used to access the account.

13. The method of claim 9, further comprising determining information about a user location from the mobile device and information about a location of the ATM.

14. The method of claim 13, further comprising determining whether the user location and ATM location are the same.

15. The method of claim 9, wherein the user enters an amount to withdraw, deposit, and/or transfer through the mobile device.

16. A system, comprising:
a memory device storing user account information, wherein the user account information comprises the user's mobile number, network address, and financial account information; and
a processor operable to:
receive identifying information from a user
generate a security code;
transmit the code to a mobile device associated with the mobile number;
receive a code entered into an automated teller machine (ATM);
compare the code received with the code transmitted; and
grant access to a financial account associated with the mobile number if the code received matches the code transmitted.

17. The system of claim 16, wherein the code is time-sensitive, for one-time use, or both.

18. The system of claim 16, wherein the processor is further operable to determine information about a user location from the mobile device and information about a location of the ATM.

19. The method of claim 18, wherein the processor is further operable to determine whether the user location and ATM location are the same.

20. The method of claim 16, wherein the identifying information does not comprise a card or a personal identification number.
